(19) United States
(12) Patent Application Publication
(10) Pub. No.: US 2019/0286141 A1
(43) Pub. Date: Sep. 19, 2019

(54) VEHICLE CONTROL APPARATUS

(71) Applicant: HONDA MOTOR CO., LTD., TOKYO (JP)

(72) Inventors: Hiroshi MIURA, WAKO-SHI (JP); Suguru YANAGIHARA, WAKO-SHI (JP); Marina SAIKYO, WAKO-SHI (JP); Toshifumi SUZUKI, WAKO-SHI (JP); Shogo KOBAYASHI, WAKO-SHI (JP)

(21) Appl. No.: 16/353,656

(22) Filed: Mar. 14, 2019

(30) Foreign Application Priority Data
Mar. 16, 2018 (JP) 2018-048809

(51) Int. Cl. G05D 1/00; B60W 50/00; G05D 1/02

(52) U.S. Cl. CPC G05D 1/0088; B60W 50/0098; G05D 1/0212; G05D 1/0257; B60W 2420/42; B60W 2420/52; G05D 1/0231; B60W 2550/22

(57) ABSTRACT

A vehicle control apparatus includes a signal recognizing section that recognizes an output state of a traffic signal, a passage permission judging section that judges whether passage of a host vehicle through an intersection is allowed, and a driving control section that performs travel control of the host vehicle. The passage permission judging section changes a judgment standard for whether to allow passage of the host vehicle through the intersection in a transitional state, when the host vehicle is in the intersection and the output state of the traffic signal is the transitional state.

### CROSS-REFERENCE TO RELATED APPLICATION

This application is based upon and claims the benefit of priority from Japanese Patent Application No. 2018-048809 filed on Mar. 16, 2018, the contents of which are incorporated herein by reference.

### BACKGROUND OF THE INVENTION

### Field of the Invention

The present invention relates to a vehicle control apparatus that automatically performs, at least partially, travel control of a host vehicle.

### Description of the Related Art

A conventional vehicle control apparatus is known that automatically performs, at least partially, travel control of a host vehicle. For example, various types of driving support enabling a host vehicle to travel smoothly near an intersection are being developed.

Japanese Laid-Open Patent Publication No. 2013-149053 describes, when it is judged that a right turn cannot be completed in a case where a vehicle attempts to make a right turn at an intersection after the green light for a right turn has ended, notifying the vehicle to stop the right turn.

### SUMMARY OF THE INVENTION

In a case where a host vehicle travelling in a travel lane makes a right or left turn (left turn in the U.S., right turn in Japan) at an intersection, if the traffic conditions are such that there is plenty of time until the traffic signal changes to red or there is little traffic flow in an opposing lane that opposes the lane of travel, the vehicle can turn left or right without remaining in the intersection. In other words, depending on the traffic conditions, the host vehicle can turn left or right while continuing the automated driving.

However, since the traffic signal changes to red in a short time after changing from green to yellow while the host vehicle passes through the intersection, there are cases where the host vehicle will be stuck in the intersection. As a result, there is a possibility of disrupting the flow of traffic in other lanes that intersect with the lane of travel and the opposite lane at the intersection. The Publication mentioned above does not consider any countermeasures for such a case where the host vehicle remains in the intersection.

The present invention aims to solve the above problem, and it is an objective of the present invention to provide a vehicle control apparatus capable of preventing a vehicle from being stuck in an intersection, so as not to disturb the flow of traffic around the intersection.

The vehicle control apparatus according to the present invention is a vehicle control apparatus that performs travel control of a host vehicle, at least partially automatically, comprising a signal recognizing section that recognizes an output state of a traffic signal installed at an intersection through which the host vehicle attempts to pass; a passage permission judging section that judges whether passage of the host vehicle through the intersection is allowed, based on the output state of the traffic signal recognized by the signal recognizing section; and a driving control section that performs the travel control based on a judgment result of the passage permission judging section, wherein the output state of the traffic signal includes a first state in which the host vehicle is allowed to progress, a second state in which the host vehicle is prohibited from progressing, and a third state during which a transition is made from the first state to the second state, and the passage permission judging section changes a judgment standard for whether to allow passage of the host vehicle through the intersection in the third state from a judgment standard in the first state, when the host vehicle is in the intersection and the output state of the traffic signal is the third state.

In this way, it is possible to prevent the host vehicle from remaining in the intersection by switching the judgment standards for whether passage of the host vehicle through the intersection is allowed, according to the output state of the traffic signal. As a result, it is possible to prevent a disturbance in the flow of traffic around the intersection.

In this case, the first state is a green light output state, the second state is a red light output state, and the third state is a yellow light output state. By changing the judgment standards for the time span of the green light and the time span of the yellow light, it is possible for the host vehicle in the intersection to quickly pass through even when the traffic signal has switched from the green light to the yellow light.

The judgment standard in the third state may be looser than the judgment standard in the first state. In this way, if the traffic signal has switched from the green light to the yellow light, even though the safety margin for the passage through the intersection is decreased, the left or right turn of the host vehicle in the intersection is allowed and the host vehicle passes through. As a result, it is possible to prevent the host vehicle from remaining in the intersection, and to reliably prevent a disturbance in the traffic flow from occurring around the intersection 90.

When the host vehicle traverses an opposing lane that opposes a travel lane from the travel lane to make a left or right turn at the intersection, along a scheduled travel route, the passage permission judging section may consider a state of the host vehicle or a state of an opposing vehicle travelling on the opposing lane and cause the judgment standard in the first state and the judgment standard in the third state to be different from each other. In this way, it is possible to allow the host vehicle to turn left or right at the intersection, while avoiding a collision with the opposing vehicle.

Specifically, for the first state and the third state, the passage permission judging section may consider a deceleration operation of the opposing vehicle and change the judgment standard for the left or right turn of the host vehicle in the intersection or the judgment standard for stopping the host vehicle in front of the intersection. In this way, if the opposing vehicle performs a deceleration operation, there is a high possibility that the opposing vehicle will stop in front of the intersection, and therefore it is possible to allow the host vehicle to turn left or right in the intersection.

The passage permission judging section, for the first state and the third state, may change the judgment standard for the left or right turn of the host vehicle in the intersection or the judgment standard for stopping the host vehicle in front of the intersection, according to a stopping position of the host vehicle. In this way, if the host vehicle stops after already having entered into the intersection, in order to prevent the host vehicle from remaining in the intersection, it is possible to allow the host vehicle to turn left or right in the intersection and quickly leave the intersection.

The passage permission judging section, for the first state and the third state, may consider a possibility of a left or right turn of an opposing vehicle according to a deceleration operation and direction indicator operation of the opposing vehicle, and change the judgment standard such that the host vehicle turns left or right before the opposing vehicle does. In this way, it is possible to allow the host vehicle to turn left or right without colliding with the opposing vehicle.

The passage permission judging section does not allow the host vehicle to progress into the intersection if the host vehicle is not within the intersection and the output state is the second state or the third state. In this way, when the traffic signal has switched from the green light to the yellow light or from the yellow light to the red light, it is possible to prevent the host vehicle from entering into the intersection.

The vehicle control apparatus is a vehicle control apparatus that performs travel control of a host vehicle, at least partially automatically, comprising a signal recognizing section that recognizes an output state of a traffic signal installed at an intersection through which the host vehicle attempts to pass; a passage permission judging section that judges whether passage of the host vehicle through the intersection is allowed, based on the output state of the traffic signal recognized by the signal recognizing section; and a driving control section that performs the travel control based on a judgment result of the passage permission judging section, wherein the output state of the traffic signal includes a first state in which the host vehicle is allowed to progress, a second state in which the host vehicle is prohibited from progressing, and a third state during which a transition is made from the first state to the second state, and when the host vehicle traverses an opposing lane that opposes a travel lane from the travel lane to make a left or right turn at the intersection, along a scheduled travel route, if the host vehicle is in the intersection and the output state of the traffic signal is the third state, the passage permission judging section changes a judgment standard for whether passage of the host vehicle through the intersection is allowed, by changing a probability of an opposing vehicle travelling on the opposing lane stopping in front of the intersection or a probability of the opposing vehicle conceding a left or right turn to the host vehicle in the intersection.

In this way, by changing the predicted vehicle stopping probability or the concession probability based on the behavior of the opposing vehicle and switching the judgment standard for whether the host vehicle in the intersection is allowed to pass through, according to the output state of the traffic signal, it is possible to prevent the host vehicle from remaining in the intersection. As a result, it is possible to prevent disturbance of the traffic flow around the intersection.

In this case as well, the first state is a green light output state, the second state is a red light output state, and the third state is a yellow light output state, and therefore by changing the judgment standards for the time span of the green light and the time span of the yellow light, it is possible for the host vehicle in the intersection to quickly pass through even when the traffic signal has switched from the green light to the yellow light.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram showing the configuration of a vehicle control apparatus according to an embodiment of the present invention.

FIG. 2 is a flow chart provided to describe the operations of the vehicle control apparatus of FIG. 1.

FIG. 3 is a flow chart showing the details of step S7 of FIG. 2.

FIG. 4 shows a case where the host vehicle enters into the intersection.

FIG. 5 shows a case where the host vehicle that has entered into the intersection leaves the intersection.

### DESCRIPTION OF THE PREFERRED EMBODIMENTS

The following describes examples of preferred embodiments of the vehicle control apparatus according to the present invention, while the accompanying drawings are referred to.

### [1. Configuration of the Vehicle Control Apparatus 10]

### <1.1 Entire Configuration>

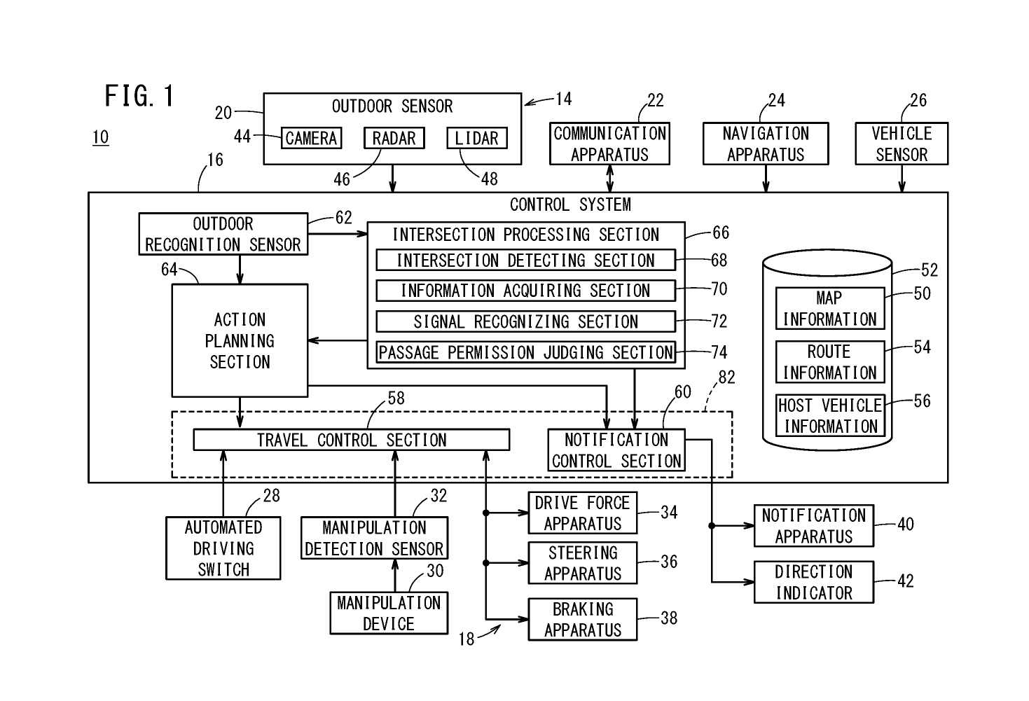

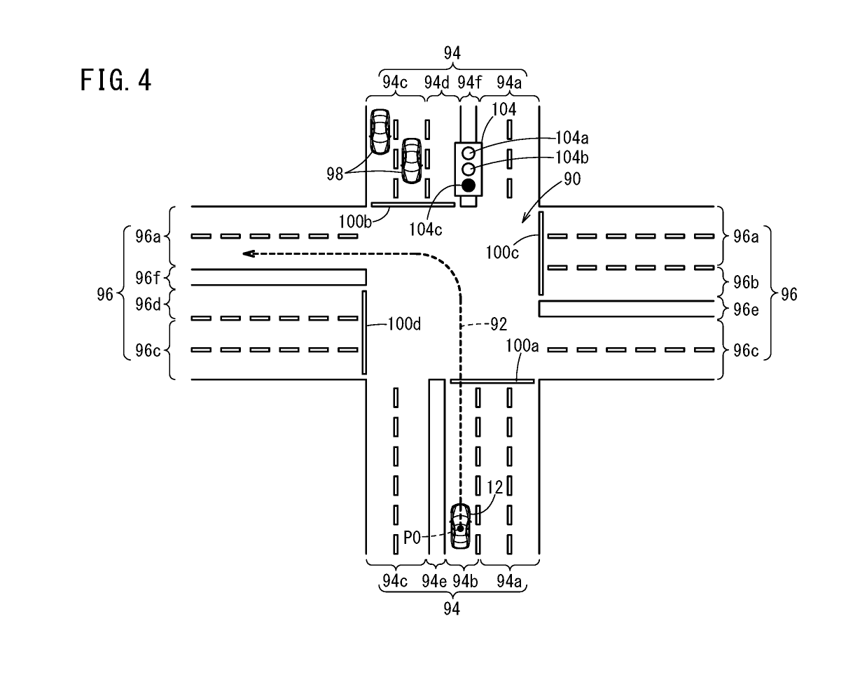

FIG. 1 is a block diagram showing the configuration of a vehicle control apparatus 10 according to an embodiment of the present invention. The vehicle control apparatus 10 is incorporated in a vehicle 12 (also referred to below as a host vehicle 12) that is shown in FIG. 4, and performs travel control of the host vehicle 12 automatically or manually. Here, “automated driving” is a concept that includes not only “completely automated driving” where all of the travel control of the host vehicle 12 is performed automatically, but also includes “partially automated driving” where part of the travel control is performed automatically. Furthermore, “travel control” refers to control relating to the travelling of the host vehicle 12, including at least acceleration and deceleration control of the host vehicle 12. In the description below, an example is described of a case where the host vehicle 12 is travelling on a road in a geographical region (e.g. the U.S.) where it is decided that vehicles travel on the right side of the road.

The vehicle control apparatus 10 shown in FIG. 1 is basically formed by an input system apparatus group 14, a control system 16, and an output system apparatus group 18. Each of the apparatuses forming the input system apparatus group 14 and the output system apparatus group 18 is connected to the control system 16 through communication lines.

The input system apparatus group 14 includes an outdoor sensor 20, a communication apparatus 22, a navigation apparatus 24, a vehicle sensor 26, an automated driving switch 28, and a manipulation detection sensor 32 that is connected to a manipulation device 30.

The output system apparatus group 18 includes a drive force apparatus 34 that drives wheels (not shown in the drawing), a steering apparatus 36 that steers these wheels, a braking apparatus 38 that brakes these wheels, a notification apparatus 40 that notifies a driver visually or audibly, and a direction indicator 42 that provides notification to the outside about the direction of a left or right turn by the host vehicle 12.

### <1.2. Specific Configuration of the Input System Apparatus Group 14>

The outdoor sensor 20 acquires information (referred to below as outdoor information) indicating the state outside the host vehicle 12, and outputs this outdoor information to the control system 16. Specifically, the outdoor sensor 20 is configured to include a plurality of cameras 44, a plurality of radars 46, and a plurality of LIDARs 48 (Light Detection and Ranging/Laser Imaging Detection and Ranging).

The communication apparatus 22 is configured to be able to communicate with external apparatuses including street-side devices, other vehicles, and servers, and transmits and receives information concerning traffic equipment, information concerning another vehicle, probe information, or latest map information 50. This map information 50 is stored in a prescribed memory region of a storage apparatus 52 provided to the control system 16 or in the navigation apparatus 24.

The navigation apparatus 24 is formed to include a satellite positioning apparatus, capable of detecting the current position of the host vehicle 12, and a user interface (e.g. a touch panel display, speaker, and microphone). The navigation apparatus 24 calculates a route to a designated destination based on the current position of the host vehicle 12 or a position designated by the user, and outputs this route to the control system 16. The route calculated by the navigation apparatus 24 is stored as route information 54 in a prescribed memory region of the storage apparatus 52.

The vehicle sensor 26 includes a velocity sensor that detects the travel velocity (vehicle velocity) of the host vehicle 12, an acceleration sensor that detects acceleration, a lateral G sensor that detects lateral G, a yaw rate sensor that detects angular velocity around a vertical axis, a direction sensor that detects orientation and direction, and a gradient sensor that detects a gradient, and outputs detections signals from each of these sensors to the control system 16. These detection signals are stored as host vehicle information 56 in a prescribed memory region of the storage apparatus 52.

The automated driving switch 28 is formed from a push-button hardware switch or a software switch using the navigation apparatus 24, for example. The automated driving switch 28 is configured to be able to switch among a plurality of driving modes in response to manual manipulation by a user, including the driver.

The manipulation device 30 is formed to include an acceleration pedal, a steering wheel, a brake pedal, a shift stick, and a direction indicating lever. The manipulation detection sensor 32 that detects whether there is a manipulation by the driver, the amount of this manipulation, and the position of this manipulation is attached to the manipulation device 30.

The manipulation detection sensor 32 outputs an acceleration pedal depression amount (acceleration pedal opening amount), a steering wheel manipulation amount (steering amount), a brake pedal depression amount, a shift position, a right/left turn direction, and the like as detection results to a travel control section 58 of the control system 16, which is described further below.

### <1.3. Specific Configuration of the Output System Apparatus Group 18>

The drive force apparatus 34 is formed from a drive force ECU (Electronic Control Unit) and a drive source including an engine and drive motor. The drive force apparatus 34 generates the travel drive force (torque) of the host vehicle 12 according to a travel control value input from the travel control section 58, and transmits this travel drive force to the wheels either directly or via a transmission.

The steering apparatus 36 is formed from an EPS (Electric Power Steering) ECU and an EPS apparatus. The steering apparatus 36 changes the orientation of the wheels (steered wheels) according to the travel control value input from the travel control section 58.

The braking apparatus 38 is an electric servo brake that also uses a hydraulic brake, for example, and is formed from a brake ECU and a brake actuator. The braking apparatus 38 brakes the wheels according to a travel control value input from the travel control section 58.

The notification apparatus 40 is formed from a notification ECU, a display apparatus, and an audio apparatus. The notification apparatus 40 provides notification relating to automated driving or manual driving, in response to notification instructions output from a notification control section 60 of the control system 16, which is described further below. The direction indicator 42 provides notification relating to a left or right turn of the host vehicle 12, in response to notification instructions output from the notification control section 60.

### <1.4. Configuration of the Control System 16>

The control system 16 is formed by one or more ECUs, and includes the storage apparatus 52, the travel control section 58, and the notification control section 60 described above, as well as sections for realizing various functions. In the present embodiment, the function realizing sections are software function sections that realize functions by having one or more CPUs (Central Processing Units) execute programs stored in the non-transitory storage apparatus 52. Instead, the function realizing sections may be hardware function sections made from an integrated circuit such as an FPGA (Field-Programmable Gate Array).

The control system 16 is formed to include the storage apparatus 52, the travel control section 58, and the notification control section 60, as well as an outdoor recognizing section 62, an action planning section 64, and an intersection processing section 66.

The outdoor recognizing section 62 uses the various pieces of information (e.g. the outdoor information from the outdoor sensor 20) input by the input system apparatus group 14 to recognize lane markers (white lines) on both sides of the host vehicle 12 and generate “static” outdoor recognition information including position information of stop lines and/or traffic signals or regions where travel is possible. Furthermore, the outdoor recognizing section 62 uses the various pieces of information input thereto to generate “dynamic” outdoor recognition information including obstructions such as stopped vehicles or the like; traffic participants such as people, other vehicles, and/or the like; or the color of traffic signals.

The action planning section 64 creates an action plan (time sequence of events) for every travel segment, based on the recognition results obtained by the outdoor recognizing section 62, and updates this action plan as necessary. The types of events are deceleration, acceleration, branching, merging, intersection, staying in the lane, lane change, and overtaking, for example. Here, “deceleration” and “acceleration” are events causing the host vehicle 12 to decelerate or accelerate. “Branching”, “merging”, and “intersection” are events causing the host vehicle 12 to travel smoothly at a branching point, a merging point or intersection. “Lane change” is an event causing the host vehicle 12 to change the travel lane, e.g. to change course. “Overtaking” is an event causing the host vehicle 12 to overtake a vehicle travelling in front of the host vehicle 12.

Furthermore, “staying in the lane” is an event causing the host vehicle 12 to travel without deviating from the travel lane, and can be broken down according to combinations of travel conditions. Specific travel conditions include travel at constant speed, travel to follow, travel to decelerate, travel on a curve, and travel to avoid obstacles.

Furthermore, the action planning section 64 uses the map information 50, the route information 54, and the host vehicle information 56 read from the storage apparatus 52 to generate a travel trajectory (a time sequence of target behaviors) according to the created action plan. This travel trajectory is, specifically, a time-sequence data set in which the position, attitude angle, velocity, acceleration, curvature, yaw rate, and steering angle are data units.

The intersection processing section 66 uses the various pieces of information from the outdoor recognizing section 62 or the action planning section 64 to perform processing relating to passage through an intersection (proceeding straight or making a left or right turn). The intersection processing section 66 then outputs an instruction signal for performing the processing described above toward the action planning section 64 or the notification control section 60. In this case, the intersection processing section 66 functions as an intersection detecting section 68, an information acquiring section 70, a signal recognizing section 72, and a passage permission judging section 74.

The travel control section 58 determines various travel control values for controlling the travel of the host vehicle 12, including at least a value for controlling acceleration and deceleration of the host vehicle 12, in accordance with the travel trajectory (time sequence of target behaviors) generated by the action planning section 64. The travel control section 58 then outputs each acquired travel control value to the drive force apparatus 34, the steering apparatus 36, and the braking apparatus 38.

The notification control section 60 controls the drive of the notification apparatus 40 or the direction indicator 42 according to the instructions from the intersection processing section 66 and the travel trajectory generated by the action planning section 64. Below, there are cases where the travel control section 58 and the notification control section 60 are referred to collectively as a “driving control section 82”.

### [2. Operation of the Vehicle Control Apparatus 10]

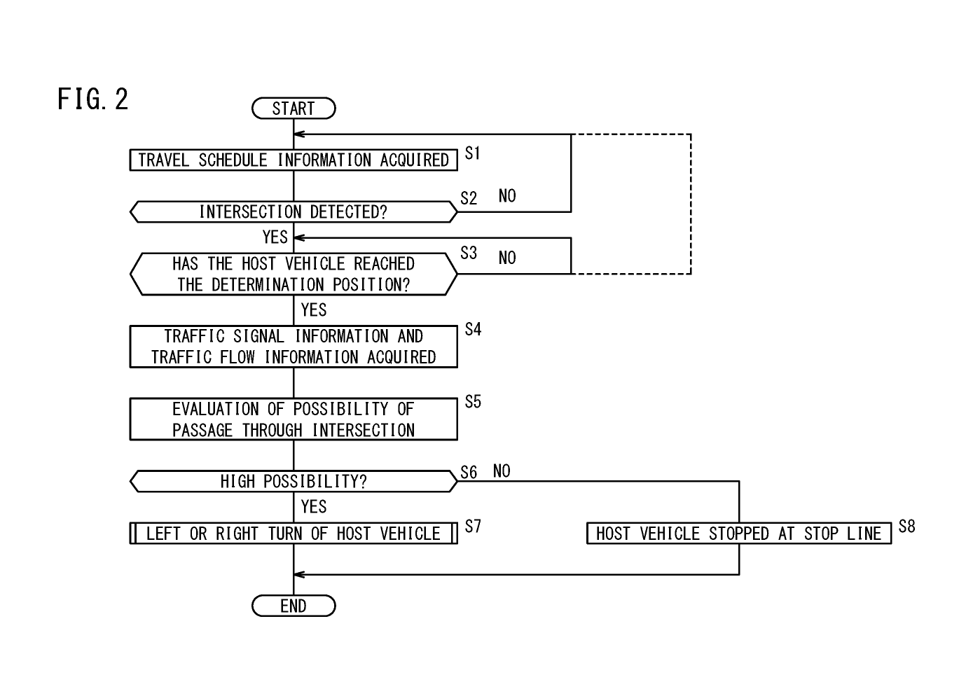

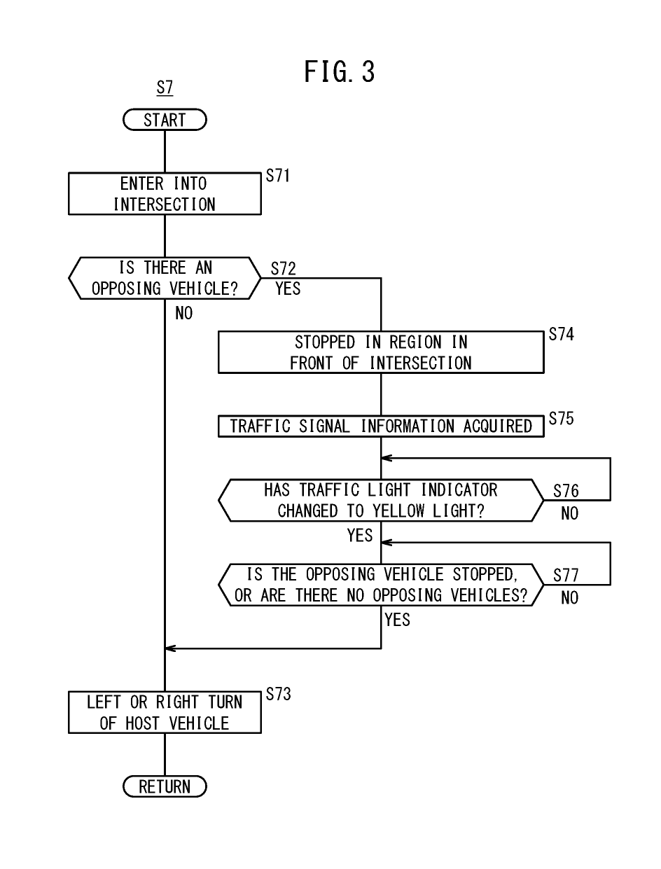

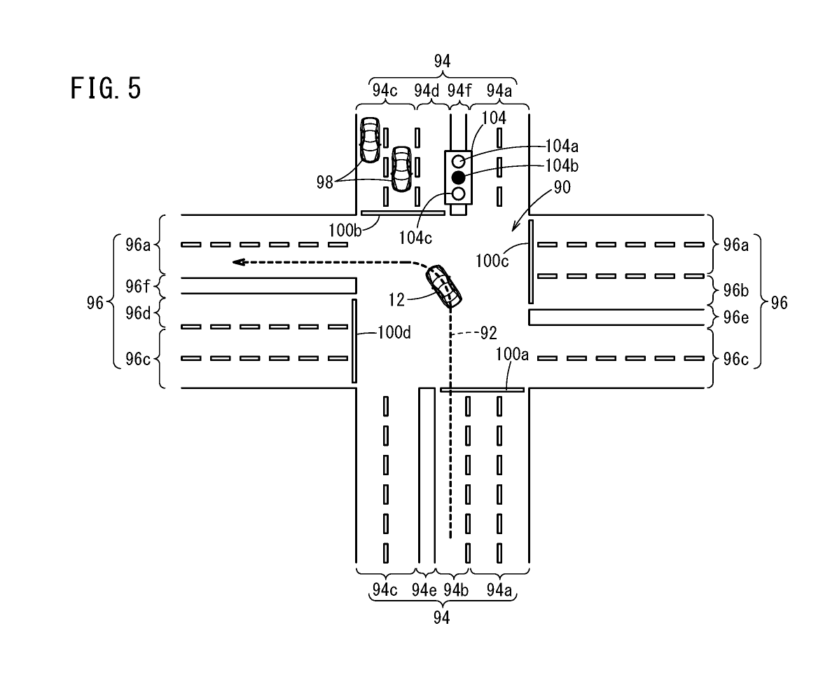

The vehicle control apparatus 10 according to the present embodiment is configured as described above. The following describes the operation of the vehicle control apparatus 10 when making a left or right turn at an intersection, while mainly referencing the flow charts of FIG. 2 and FIG. 3. Here, a case is described in which the host vehicle 12 with the vehicle control apparatus 10 mounted therein is travelling on the right side of the road with automated driving, and makes a left turn at an intersection 90 shown in FIG. 4 and FIG. 5.

### <2.1. Description of the Intersection 90>

FIG. 4 shows a state in which the host vehicle 12 has proceeded into the intersection 90, and FIG. 5 shows a state where the host vehicle 12 is turning left in the intersection 90. The host vehicle 12 attempts to pass through the intersection 90 where a first road 94 and a second road 96 intersect, along the scheduled travel route 92 indicated by the dashed line arrow. The first road 94 and the second road 96 are each 5-lane roads.

Specifically, the first road 94 is formed including a first travel lane region 94a including two lanes on which vehicles can proceed straight, a first left-turn lane 94b that is adjacent to the first travel lane region 94a and is a lane in which vehicles, including the host vehicle 12, can turn left, a first opposing lane region 94c that is opposite to the first travel lane region 94a and includes two lanes on which opposing vehicles 98 can proceed straight, and a first left-turn lane 94d that is adjacent to the first opposing lane region 94c and is a lane in which the opposing vehicles 98 can turn left.

In this case, as seen from the host vehicle 12, on the close side of the intersection 90, the three travel lanes formed by the first travel lane region 94a and the first left-turn lane 94b and the two lanes of the first opposing lane region 94c are separated by a divider 94e. Furthermore, on the far side of the intersection 90 (beyond the intersection 90 in the progression direction of the vehicle), the two lanes of the first travel lane region 94a and the three opposing lanes formed by the first opposing lane region 94c and the first left-turn lane 94d are separated by a divider 94f.

In other words, the side of the first road 94 in front of the intersection 90 is formed as a 5-lane road including the first travel lane region 94a, the first left-turn lane 94b, and the first opposing lane region 94c, and the side of the first road 94 beyond the intersection 90 is formed as a 5-lane road by the first travel lane region 94a, the first opposing lane region 94c, and the first left-turn lane 94d.

On the other hand, in a similar manner as the first road 94, the second road 96 is formed including a second travel lane region 96a including two lanes on which vehicles can proceed straight, a second left-turn lane 96b that is adjacent to the second travel lane region 96a and is a lane in which vehicles can turn left, a second opposing lane region 96c that is opposite to the second travel lane region 96a and includes two lanes on which vehicles can proceed straight, and a second left-turn lane 96d that is adjacent to the second opposing lane region 96c and is a lane in which the opposing vehicles can turn left.

In this case, as seen from the host vehicle 12, on the right side of the intersection 90, the three travel lanes formed by the second travel lane region 96a and the second left-turn lane 96b and the two lanes of the second opposing lane region 96c are separated by a divider 96e. Furthermore, on the left side of the intersection 90, the two lanes of the second travel lane region 96a and the three opposing lanes formed by the second opposing lane region 96c and the second left-turn lane 96d are separated by a divider 96f.

Accordingly, the side of the second road 96 to the right of the intersection 90 is formed as a 5-lane road including the second travel lane region 96a, the second left-turn lane 96b, and the second opposing lane region 96c, and the side of the second road 96 to the left of the intersection 90 is formed as a 5-lane road by the second travel lane region 96a, the second opposing lane region 96c, and the second left-turn lane 96d.

Furthermore, the first travel lane region 94a and the first left-turn lane 94b, the first opposing lane region 94c and the first left-turn lane 94d, the second travel lane region 96a and the second left-turn lane 96b, and the second opposing lane region 96c and the second left-turn lane 96d are respectively provided with stop lines 100a to 100d directly in front of the intersection 90.

A traffic signal 104 that indicates the passage permission/prohibition state when a vehicle, including the host vehicle 12, turns left is provided on the intersection 90 side of the divider 94f. The traffic signal 104 is a vertical traffic signal, and indicates the passage permission/prohibition state of the host vehicle 12 when the host vehicle 12 turns left at the intersection 90 along the scheduled travel route 92.

Specifically, the traffic signal 104 is provided facing the vehicles, including the host vehicle 12, that travel in the first left-turn lane 94b, and three display sections 104a to 104c are arranged therein from top to bottom. The display section 104c at the bottom indicates that the current state is a progress-allowed state (first state) using a green light, which is a green signal. Furthermore, the display section 104a on the top indicates that the current state is a progress-disallowed state (second state) using a red light, which is a red signal. Yet further, the display section 104b in the center indicates that the current state is a transitional state (third state) during a transition from the progress-allowed state to the progress-disallowed state using a yellow light, which is a yellow signal. Here, the “progress-allowed state” is a state where vehicles, including the host vehicle 12, are allowed to progress, and the “progress-disallowed state” is a state where vehicles, including the host vehicle 12, are prohibited from progressing.

In the example of FIG. 4, the traffic signal 104 lights up the green light (display section 104c) to indicate the progress-allowed state (state where a left turn is possible). Furthermore, in FIG. 5, the traffic signal 104 lights up the yellow light (display section 104b) to indicate the transitional state. In other words, FIGS. 4 and 5 show a case where it is decided that vehicles, including the host vehicle 12, travel on the right side of the road, and the host vehicle 12 turns left at the intersection 90. It should be noted that, in a geographical region where it is decided that vehicles, including the host vehicle 12, travel on the left side of the road, the host vehicle 12 would turn to the right at the intersection 90.

In FIGS. 4 and 5, for convenience of the description, only the traffic signal 104 corresponding to the vehicle (host vehicle 12) entering into the intersection 90 from the first left-turn lane 94b to make a left turn is shown. In actuality, traffic signals are also arranged around the intersection 90 corresponding to each of the first travel lane region 94a, the first opposing lane region 94c, the first left-turn lane 94d, the second travel lane region 96a, the second left-turn lanes 96b and 96d, and the second opposing lane region 96c.

### <2.2. Description of the Operation of FIG. 2>

The operation of the vehicle control apparatus 10 shown in the flowchart of FIG. 2 is explained with the development of a situation where the host vehicle 12 travels on the scheduled travel route 92.

First, in a case where the host vehicle 12 is travelling on the first road 94 (in the first left-turn lane 94b), at step S1 of FIG. 2, the intersection processing section 66 (see FIG. 1) uses the route information 54 most recently stored in the storage apparatus 52 or the “static” outdoor recognition information generated by the outdoor recognizing section 62 to acquire the scheduled travel route 92 (see FIGS. 4 and 5) on which the host vehicle 12 intends to travel.

At step S2, the intersection detecting section 68 detects the intersection 90 by considering the scheduled travel route 92 acquired at step S1 and the action plan (left or right turn event) created by the action planning section 64. As described above, the intersection 90 is an intersection that (1) is on the scheduled travel route 92, (2) has a plurality of lanes intersecting, (3) is a location where the host vehicle 12 is scheduled to make a left turn, and (4) is within a prescribed distance range from the current host vehicle position (e.g. the host vehicle position P0) or can be reached by the host vehicle 12 within a prescribed time range.

If the intersection 90 is not detected (step S2: NO), the process returns to step S1 and then steps S1 and S2 are sequentially repeated. On the other hand, if the specified intersection 90 is detected (step S2: YES), the process proceeds to step S3.

At step S3, the intersection processing section 66 determines whether the host vehicle 12 has reached a position (determination position) that is a prescribed travel distance in front of the intersection 90. If the host vehicle 12 has not yet reached the determination position (step S3: NO), step S3 is put on hold until the host vehicle 12 reaches the determination position.

If the scheduled travel route 92 is changed before the host vehicle 12 reaches the determination position, there is a possibility that the host vehicle 12 will not reach the determination position (step S3: NO), and therefore the process may return to step S1, as shown by the dashed line. On the other hand, if it is determined that the host vehicle 12 has reached the determination position (step S3: YES), the process proceeds to step S4.

At step S4, the information acquiring section 70 acquires traffic signal information and/or traffic flow information from VICS (Vehicle Information and Communication System; Registered Trademark), via the communication apparatus 22. Here, the “traffic signal information” is information relating to the time during which the traffic signal 104 lights up, and TSPS (Traffic Signal Prediction Systems) may be used, for example. The “traffic flow information” is information relating to the traffic flow in the first opposing lane region 94c, and the newest traffic jam information, traffic obstacle information, or traffic rule information may be used. Furthermore, the information acquiring section 70 acquires the traffic signal information by learning the light-up time of each display section 104a to 104c of the traffic signal 104 based on images of the traffic signal 104 captured by the cameras 44. Yet further, the signal recognizing section 72 recognizes the output state of the traffic signal 104, i.e. the light-up state of each display section 104a to 104c, arranged at the intersection 90 through which the host vehicle 12 is attempting to pass, based on the acquired traffic signal information.

At step S5, the passage permission judging section 74 evaluates the possibility of the host vehicle 12 passing through the intersection 90, using the recognition results of the signal recognizing section 72 and each type of information acquired at step S4. Specifically, the passage permission judging section 74 evaluates the time relating to a left turn of the host vehicle 12, using the recognition results of the signal recognizing section 72 and the traffic signal information and/or traffic flow information. More specifically, this calculation process evaluates whether the host vehicle 12 can pass through the intersection 90 by referencing the time during which the green light of the display section 104c of the traffic signal 104 is lit-up and the travel time needed for the host vehicle 12 to reach the intersection 90 (the position of the stop line 100a), before the host vehicle 12 reaches the intersection 90.

At step S6, if the passage permission judging section 74 has judged that there is a high possibility of passing through the intersection 90 (step S6: YES), the process proceeds to step S7. At step S7, the intersection processing section 66 performs processing to turn left in the intersection 90, after the host vehicle 12 has entered into the intersection 90. Specifically, the intersection processing section 66 notifies the action planning section 64 that there is no need for a change in the action plan. The action planning section 64 generates the travel trajectory for changing the route from the first left-turn lane 94b to the second travel lane region 96a, according to the initial action plan. In this way, the travel control section 58 performs travel control to turn the host vehicle 12 left at the intersection 90, according to this travel trajectory. The specific processing content is described further below.

On the other hand, if the passage permission judging section 74 has judged at step S6 that there is a low possibility of passing through the intersection 90 (step S6: NO), specifically if the passage permission judging section 74 has judged that the host vehicle 12 is not allowed to enter into the intersection 90 because the traffic signal 104 has switched from the green light to the yellow light or from the yellow light to the red light, the process proceeds to step S8. At step S8, the intersection processing section 66 performs processing to stop the host vehicle 12 at the stop line 100a without entering into the intersection 90. Specifically, the intersection processing section 66 notifies the action planning section 64 that a temporary stop is necessary. The action planning section 64 changes the action plan based on the notification content from the intersection processing section 66, and generates a vehicle trajectory to temporarily stop in front of the intersection 90. In this way, the travel control section 58 performs travel control to decelerate and stop the host vehicle 12 in front of the intersection 90, according to the travel trajectory.

### <2.3. Description of the Operation of FIG. 3>

The following describes in detail the process of step S7 of FIG. 2 (the process relating to the left turn in the intersection 90), while the flow chart of FIG. 3 is referred to.

At step S71 of FIG. 3, the driving control section 82 performs travel control to cause the host vehicle 12 to enter into the intersection 90 along the scheduled travel route 92 (see FIG. 5), in the progress-allowed state (first state) where the display section 104c of the traffic signal 104 is lit-up green. In this case, the signal recognizing section 72 recognizes the current state of the display section 104c being lit-up green, i.e. the progress-allowed state, based on the traffic signal information.

At step S72, the passage permission judging section 74 determines whether there is an opposing vehicle 98. In this case, if the recognition result by the signal recognizing section 72 indicates the progress-allowed state and there are no opposing vehicles 98 (step S72: NO), the passage permission judging section 74 moves the process to step S73.

At step S73, the driving control section 82 performs travel control to turn the host vehicle 12 left at the intersection, while continuing movement of the host vehicle 12. Due to this, the host vehicle 12 traverses the first opposing lane region 94c to move into the second travel lane region 96a, while turning to the left. In this way, the left turn of the host vehicle 12 at the intersection 90 is completed.

On the other hand, if, at step S72, the recognition result by the signal recognizing section 72 indicates the progress-allowed state but there is an opposing vehicle 98 (step S72: YES), the process proceeds to step S74. At step S74, the driving control section 82 performs travel control to temporarily stop the host vehicle 12 in the intersection 90. After this, at step S75, the information acquiring section 70 reacquires the traffic signal information at the current time.

At step S76, the signal recognizing section 72 recognizes the current output state of the traffic signal 104, based on the reacquired traffic signal information. Next, the passage permission judging section 74 judges whether the output state of the traffic signal 104 has switched from the green light (the display section 104c being lit-up) to the yellow light (the display section 104b being lit-up). If the traffic signal 104 has not switched to the yellow light (step S76: NO), the process remains at step S76.

On the other hand, if the signal recognizing section 72 judges that the traffic signal 104 has switched from the green light to the yellow light (step S76: YES), the process proceeds to step S77. At step S77, the passage permission judging section 74 judges whether the opposing vehicle 98 is stopped in front of the stop line 100b or whether there are no opposing vehicles 98, based on the traffic flow information acquired by the information acquiring section 70. If the opposing vehicle 98 has entered into the intersection 90 or if there is the possibility that the opposing vehicle 98 will enter into the intersection 90 (step S77: NO), the process remains at step S77.

On the other hand, if the opposing vehicle 98 has stopped in front of the stop line 100b or if there are no opposing vehicles 98 (step S77: YES), the passage permission judging section 74 judges that the host vehicle 12 should pass through the intersection 90 even though the yellow light of the traffic signal 104 is lit-up. In this way, at step S73, the driving control section 82 causes the host vehicle 12 to pass from inside the intersection 90 and complete the left turn.

Specifically, when the traffic signal 104 switches from the yellow light to the red light in a state where the host vehicle 12 is still in the intersection 90, the traffic signal of the second road 96 switches to the green light and the vehicles having stopped at the stop lines 100c and 100d begin to travel and enter into the intersection 90. As a result, the traffic flow of the vehicles travelling on the second road 96 is disturbed due to the host vehicle 12 remaining in the intersection 90. In order to avoid such a situation, the host vehicle 12 should turn left in the intersection 90 quickly, even when the yellow light of the traffic signal 104 is lit-up.

### <2.4. Judgment Standards of Steps S6, S72, and S77>

In order to perform the processes described above, judgment standards for whether to allow the left turn of the host vehicle 12 at step S77 are set to be different from the judgment standards for whether to allow the left turn at steps S6 and S72. In other words, the judgment standards in step S77 are set to be looser than the judgment standards in steps S6 and S72.

Furthermore, when the host vehicle 12 traverses the first opposing lane region 94c from the first left-turn lane 94b to turn left in the intersection 90 along the scheduled travel route 92, at steps S6, S72, and S77, the passage permission judging section 74 may consider the state of the host vehicle 12 or the state of an opposing vehicle 98 and set the judgement standards in step S77 to be looser than the judgment standards in steps S6 and S72.

Specifically, in steps S6, S72, and S77, a deceleration operation of the opposing vehicle 98 may be considered and the judgment standards for a left turn of the host vehicle 12 in the intersection 90 or the judgment standards for stopping the host vehicle 12 at in front of the intersection 90 (at the stop line 100a) may be changed.

Furthermore, in steps S6, S72, and S77, if the traffic signal 104 has the green light or the yellow light lit-up, the judgment standards for a left turn of the host vehicle 12 in the intersection 90 or the judgment standards for stopping the host vehicle 12 in front of the intersection 90 may be changed according to the stop position of the host vehicle 12.

Yet further, in steps S6, S72, and S77, if the traffic signal 104 has the green light or the yellow light lit-up, the possibility of the opposing vehicle 98 making a left turn according to the deceleration operation and direction indicator operation (blinker operation) of the opposing vehicle 98 may be considered, and the judgment standards may be changed such that the host vehicle 12 turns left before the opposing vehicle 98 does. In other words, the vehicle control apparatus 10 causes the host vehicle 12 to turn left before the opposing vehicle 98 does, so that the left turn of the opposing vehicle 98 in the intersection 90 does not interfere with the left turn of the host vehicle 12.

In steps S6, S72, and S77, by changing the probability (expected vehicle stopping probability) of the opposing vehicle 98 stopping in front of the intersection (at the stop line 100b) or the probability (concession probability) of the opposing vehicle 98 conceding the left turn in the intersection 90 to the host vehicle 12, according to the output state of the traffic signal 104, the judgment standards for whether to allow passage of the host vehicle 12 in the intersection 90 may be changed. In other words, since the expected vehicle stopping probability or concession probability is based on the behavior of the opposing vehicle 98, if the opposing vehicle 98 stops or concedes the left turn (if the expected vehicle stopping probability or concession probability is high), the opposing vehicle 98 does not interfere with the left turn of the host vehicle 12. In such a case, it is possible for the host vehicle 12 to turn left quickly in the intersection 90, by having the vehicle control apparatus 10 allow the left turn of the host vehicle 12.

Using any of these judgment standards, it is possible to avoid a situation where the host vehicle 12 remains in the intersection 90 and to prevent a disturbance in the traffic flow of vehicles travelling on the second road 96.

### <2.5. Modifications>

In the above description, a case is described in which the host vehicle 12 travelling on the right side of the road turns left in the intersection 90. The operations of FIGS. 2 and 3 can also be applied to a case where the host vehicle 12 travelling on the left side of the road turns right in the intersection 90.

### [3. Effects Realized by the Vehicle Control Apparatus 10]

As described above, the vehicle control apparatus 10 is a vehicle control apparatus that performs travel control of a host vehicle 12, at least partially automatically, comprising a signal recognizing section 72 that recognizes an output state of a traffic signal 104 installed at an intersection 90 through which the host vehicle 12 attempts to pass; a passage permission judging section 74 that judges whether passage of the host vehicle 12 is allowed in the intersection 90, based on the output state of the traffic signal 104 recognized by the signal recognizing section 72; and a driving control section 82 that performs the travel control based on a judgment result of the passage permission judging section 74, wherein the output state of the traffic signal 104 includes a progress-allowed state (first state) in which the host vehicle 12 is allowed to progress, a progress-disallowed state (second state) in which the host vehicle 12 is prohibited from progressing, and a transitional state (third state) during which a transition is made from the progress-allowed state to the progress-disallowed state, and the passage permission judging section 74 changes a judgment standard for whether to allow passage of the host vehicle 12 in the intersection 90 in the transitional state from a judgment standard in the progress-allowed state, when the host vehicle 12 is in the intersection 90 and the output state of the traffic signal 104 is the transitional state.

In this way, it is possible to prevent the host vehicle 12 from remaining in the intersection 90 by switching the judgment standards for whether passage of the host vehicle 12 through the intersection 90 is allowed, according to the output state of the traffic signal 104. As a result, it is possible to prevent a disturbance in the flow of traffic around the intersection 90.

In this case, the progress-allowed state is a green light output state, the progress-disallowed state is a red light output state, and the transitional state is a yellow light output state. By setting different judgment standards for the time span of the green light and the time span of the yellow light, it is possible for the host vehicle 12 in the intersection 90 to quickly pass through even when the traffic signal 104 has switched from the green light to the yellow light.

The judgment standard in the transitional state is looser than the judgment standard in the progress-allowed state. In this way, if the traffic signal 104 has switched from the green light to the yellow light, even if the safety margin for the passage through the intersection 90 is decreased, the left or right turn of the host vehicle 12 in the intersection 90 is allowed and the host vehicle 12 is made to pass through. As a result, it is possible to prevent the host vehicle 12 from remaining in the intersection 90, and to reliably prevent a disturbance in the traffic flow from occurring around the intersection 90.

When the host vehicle 12 traverses a first opposing lane region 94c that opposes a first left-turn lane 94b from the first left-turn lane 94b to make a left or right turn at the intersection 90 along a scheduled travel route 92, the passage permission judging section 74 may consider a state of the host vehicle 12 or a state of an opposing vehicle 98 travelling on the first opposing lane region 94c and cause the judgment standard in the progress-allowed state and the judgment standard in the transitional state to be different from each other. In this way, it is possible to allow the host vehicle 12 to turn left or right at the intersection 90, while avoiding a collision with the opposing vehicle 98.

Specifically, for the progress-allowed state and the transitional state, the passage permission judging section 74 may consider a deceleration operation of the opposing vehicle 98 and change the judgment standard for the left or right turn of the host vehicle 12 in the intersection 90 or the judgment standard for stopping the host vehicle 12 in front of the intersection 90. In this way, if the opposing vehicle 98 performs a deceleration operation, there is a high possibility that the opposing vehicle 98 will stop in front of the intersection 90, and therefore it is possible to allow the host vehicle 12 to turn left or right in the intersection 90.

The passage permission judging section 74, for the progress-allowed state and the transitional state, may change the judgment standard for the left or right turn of the host vehicle 12 in the intersection 90 or the judgment standard for stopping the host vehicle 12 in front of the intersection 90, according to a stopping position of the host vehicle 12. In this way, if the host vehicle 12 stops after already having entered into the intersection 90, in order to prevent the host vehicle 12 from remaining in the intersection 90, it is possible to allow the host vehicle 12 to turn left or right in the intersection 90 and quickly leave the intersection 90.

The passage permission judging section 74, for the progress-allowed state and the transitional state, may consider a possibility of a left or right turn of an opposing vehicle 98 according to a deceleration operation and direction indicator operation (blinker operation) of the opposing vehicle 98, and change the judgment standard such that the host vehicle 12 turns left or right before the opposing vehicle 98 does. In this way, it is possible to allow the host vehicle 12 to turn left or right without colliding with the opposing vehicle 98.

The passage permission judging section 74 does not allow the host vehicle 12 to progress into the intersection 90 if the host vehicle 12 is not within the intersection 90 and the output state is the progress-disallowed state or the transitional state. In this way, when the traffic signal 104 has switched from the green light to the yellow light or from the yellow light to the red light, it is possible to prevent the host vehicle 12 from entering into the intersection 90.

The vehicle control apparatus 10 is a vehicle control apparatus 10 that performs travel control of a host vehicle 12, at least partially automatically, comprising a signal recognizing section 72 that recognizes an output state of a traffic signal 104 installed at an intersection 90 through which the host vehicle 12 attempts to pass; a passage permission judging section 74 that judges whether passage of the host vehicle 12 is allowed in the intersection 90, based on the output state of the traffic signal 104 recognized by the signal recognizing section 72; and a driving control section 82 that performs the travel control based on a judgment result of the passage permission judging section 74, wherein the output state of the traffic signal 104 includes a progress-allowed state (first state) in which the host vehicle 12 is allowed to progress, a progress-disallowed state (second state) in which the host vehicle 12 is prohibited from progressing, and a transitional state (third state) during which a transition is made from the progress-allowed state to the progress-disallowed state, and when the host vehicle 12 traverses a first opposing lane region 94c that opposes a first left-turn lane 94b from the first left-turn lane 94b to make a left or right turn at the intersection 90, along a scheduled travel route 92, if the host vehicle 12 is in the intersection 90 and the output state of the traffic signal 104 is the transitional state, the passage permission judging section 74 changes a judgment standard for whether passage of the host vehicle 12 through the intersection 90 is allowed, by changing a probability (predicted vehicle stopping probability) of an opposing vehicle 98 travelling on the first opposing lane region 94c stopping in front of the intersection 90 or a probability (concession probability) of the opposing vehicle 98 conceding a left or right turn to the host vehicle 12 in the intersection 90.

In this way, by changing the predicted vehicle stopping probability or the concession probability based on the behavior of the opposing vehicle 98 and switching the judgment standard for whether the host vehicle 12 in the intersection 90 is allowed to pass through, according to the output state of the traffic signal 104, it is possible to prevent the host vehicle 12 from remaining in the intersection 90. As a result, it is possible to prevent disturbance of the traffic flow around the intersection 90.

In this case as well, the progress-allowed state is a green light output state, the progress-disallowed state is a red light output state, and the transitional state is a yellow light output state, and therefore by setting different judgment standards for the time span of the green light and the time span of the yellow light, it is possible for the host vehicle 12 in the intersection 90 to quickly pass through even when the traffic signal 104 has switched from the green light to the yellow light.

The technical scope of the invention is not limited to the above described embodiments, and it is apparent that various alterations can be made without deviating from the scope of the present invention. Alternatively, various configuration may be arbitrarily combined, as long as the combination does not cause a technical contradiction.

What is claimed is:

1. A vehicle control apparatus that performs travel control of a host vehicle, at least partially automatically, comprising:
a signal recognizing section that recognizes an output state of a traffic signal installed at an intersection through which the host vehicle attempts to pass;
a passage permission judging section that judges whether passage of the host vehicle through the intersection is allowed, based on the output state of the traffic signal recognized by the signal recognizing section; and
a driving control section that performs the travel control based on a judgment result of the passage permission judging section, wherein
the output state of the traffic signal includes a first state in which the host vehicle is allowed to progress, a second state in which the host vehicle is prohibited from progressing, and a third state during which a transition is made from the first state to the second state, and
the passage permission judging section changes a judgment standard for whether to allow passage of the host vehicle through the intersection in the third state from a judgment standard in the first state, when the host vehicle is in the intersection and the output state of the traffic signal is the third state.

2. The vehicle control apparatus according to claim 1, wherein
the judgment standard in the third state may be looser than the judgment standard in the first state.

3. The vehicle control apparatus according to claim 2, wherein
when the host vehicle traverses an opposing lane that opposes a travel lane from the travel lane to make a left or right turn at the intersection along a scheduled travel route, the passage permission judging section considers a state of the host vehicle or a state of an opposing vehicle travelling on the opposing lane and causes the judgment standard in the first state and the judgment standard in the third state to be different from each other.

4. The vehicle control apparatus according to claim 3, wherein
the passage permission judging section, for the first state and the third state, considers a deceleration operation of the opposing vehicle and changes the judgment standard for the left or right turn of the host vehicle in the intersection or a judgment standard for stopping the host vehicle in front of the intersection.

5. The vehicle control apparatus according to claim 3, wherein
the passage permission judging section, for the first state and the third state, changes the judgment standard for the left or right turn of the host vehicle in the intersection or a judgment standard for stopping the host vehicle in front of the intersection, according to a stopping position of the host vehicle.

6. The vehicle control apparatus according to claim 3, wherein
the passage permission judging section, for the first state and the third state, considers a possibility of a left or right turn of the opposing vehicle according to a deceleration operation and direction indicator operation of the opposing vehicle, and changes the judgment standard such that the host vehicle turns left or right before the opposing vehicle does.

7. The vehicle control apparatus according to claim 1, wherein
the passage permission judging section does not allow the host vehicle to progress into the intersection if the host vehicle is not within the intersection and the output state is the second state or the third state.

8. A vehicle control apparatus that performs travel control of a host vehicle, at least partially automatically, comprising:
a signal recognizing section that recognizes an output state of a traffic signal installed at an intersection through which the host vehicle attempts to pass;
a passage permission judging section that judges whether passage of the host vehicle through the intersection is allowed, based on the output state of the traffic signal recognized by the signal recognizing section; and
a driving control section that performs the travel control based on a judgment result of the passage permission judging section, wherein
the output state of the traffic signal includes a first state in which the host vehicle is allowed to progress, a second state in which the host vehicle is prohibited from progressing, and a third state during which a transition is made from the first state to the second state, and
when the host vehicle traverses an opposing lane that opposes a travel lane from the travel lane to make a left or right turn at the intersection, along a scheduled travel route, if the host vehicle is in the intersection and the output state of the traffic signal is the third state, the passage permission judging section changes a judgment standard for whether passage of the host vehicle through the intersection is allowed, by changing a probability of an opposing vehicle travelling on the opposing lane stopping in front of the intersection or a probability of the opposing vehicle conceding a left or right turn to the host vehicle in the intersection.
